(19) United States
(12) Patent Application Publication
(10) Pub. No.: US 2023/0222763 A1
(43) Pub. Date: Jul. 13, 2023

(54) A System And Method For Identification Of Markers On Flowable-Matter Substrates

(71) Applicant: Ripples Ltd., Petah Tikva (IL)

(72) Inventor: Eyal ELIAV, Tel Aviv (IL)

(21) Appl. No.: 18/001,875

(22) PCT Filed: Jun. 21, 2021
(86) PCT No.: PCT/IL2021/050754

§ 371 Date: Dec. 15, 2022

Related U.S. Application Data
(60) Provisional application No. 63/042,571, filed on Jun. 23, 2020.

(51) Int. Cl. G06V 10/75; G06T 7/50

(52) U.S. Cl. CPC G06V 10/751; G06T 7/50; G06T 2207/30204

(57) ABSTRACT

A system for identifying markers on flowable-matter substrates, the system comprising a processing circuitry configured to: provide one or more reference images, each associated with (a) a corresponding marker, and (b) a corresponding action; obtain an image including a given marker applied on a flowable-matter substrate; identify a matching reference image of the reference images, the matching reference image being associated with the marker corresponding to the given marker; and upon identifying the matching reference image, perform the action associated with the matching reference image.

### TECHNICAL FIELD

The invention relates to marker identification and more specifically to identification of markers on flowable-matter substrates.

### BACKGROUND

Computer vision technology enables identification of markers within images analyzed by computer vision algorithms for various purposes. However, current technologies usually require the markers to be printed (or otherwise applied) on a solid surface, so that the markers are not deformed in a manner that prevents the computer from identifying same. Accordingly, when a marker is printed (or otherwise applied) on flowable-matter substrates, such as foam, existing technologies fail to identify the markers.

There is thus a need in the art for a new system and method for identification of markers on flowable-matter substrates.

### GENERAL DESCRIPTION

In accordance with a first aspect of the presently disclosed subject matter, there is provided a system for identifying markers on flowable-matter substrates, the system comprising a processing circuitry configured to: provide one or more reference images, each associated with (a) a corresponding marker, and (b) a corresponding action; obtain an image including a given marker applied on a flowable-matter substrate; identify a matching reference image of the reference images, the matching reference image being associated with the marker corresponding to the given marker; and upon identifying the matching reference image, perform the action associated with the matching reference image.

In some cases, the reference images are manipulations of corresponding original images including the corresponding marker.

In some cases, the manipulations include at least one of: (a) color manipulations manipulating the colors of the original images, (b) blur manipulations creating a blur effect on the original images, (c) hue manipulations changing the hue of the original images, or (d) adding of noise to the original images.

In some cases, the original images are provided by one or more content manufacturers.

In some cases, (a) the image includes a plurality of known geometrical shapes enabling identification of a sub-portion of the image comprising the marker, (b) the identification of the matching reference image includes analyzing the image to identify the geometrical shapes, thereby identifying the sub-portion, and (c) the matching reference image being the reference image that matches a content within the sub-portion.

In some cases, the action associated with the matching reference image includes one or more of: (a) displaying augmented reality content associated with the matching reference image to a user of the system, or (b) providing a notification to the user of the system.

In some cases, the augmented reality content is personalized to the user in accordance with one or more characteristics of the user.

In some cases, the notification is provided to the user upon one or more rules being met.

In some cases, the flowable-matter substrate is a surface of a beverage, and the image is provided by a consumer of the beverage.

In some cases, the flowable-matter substrate is edible.

In some cases, the flowable-matter substrate made of edible foam.

In some cases, the foam is of a beverage.

In some cases, the beverage is one of: coffee, beer or cocktail.

In some cases, the given marker is applied on the flowable-matter substrate by a printer printing edible ink.

In some cases, the edible ink is invisible in the visible spectrum and visible in an Ultra Violet (UV) spectrum.

In accordance with a second aspect of the presently disclosed subject matter, there is provided a method for identifying markers on flowable-matter substrates, the method comprising: providing, by a processing circuitry, one or more reference images, each associated with (a) a corresponding marker, and (b) a corresponding action; obtaining, by the processing circuitry, an image including a given marker applied on a flowable-matter substrate; identifying, by the processing circuitry, a matching reference image of the reference images, the matching reference image being associated with the marker corresponding to the given marker; and upon identifying the matching reference image, performing, by the processing circuitry, the action associated with the matching reference image.

In some cases, the reference images are manipulations of corresponding original images including the corresponding marker.

In some cases, the manipulations include at least one of: (a) color manipulations manipulating the colors of the original images, (b) blur manipulations creating a blur effect on the original images, (c) hue manipulations changing the hue of the original images, or (d) adding of noise to the original images.

In some cases, the original images are provided by one or more content manufacturers.

In some cases, (a) the image includes a plurality of known geometrical shapes enabling identification of a sub-portion of the image comprising the marker, (b) the identification of the matching reference image includes analyzing the image to identify the geometrical shapes, thereby identifying the sub-portion, and (c) the matching reference image being the reference image that matches a content within the sub-portion.

In some cases, the action associated with the matching reference image includes one or more of: (a) displaying augmented reality content associated with the matching reference image to a user of the system, or (b) providing a notification to the user of the system.

In some cases, the augmented reality content is personalized to the user in accordance with one or more characteristics of the user.

In some cases, the notification is provided to the user upon one or more rules being met.

In some cases, the flowable-matter substrate is a surface of a beverage, and the image is provided by a consumer of the beverage.

In some cases, the flowable-matter substrate is edible.

In some cases, the flowable-matter substrate made of edible foam.

In some cases, the foam is of a beverage.

In some cases, the beverage is one of: coffee, beer or cocktail.

In some cases, the given marker is applied on the flowable-matter substrate by a printer printing edible ink.

In some cases, the edible ink is invisible in the visible spectrum and visible in an Ultra Violet (UV) spectrum.

In accordance with a third aspect of the presently disclosed subject matter, there is provided a non-transitory computer readable storage medium having computer readable program code embodied therewith, the computer readable program code, executable by at least one processing circuitry of a computer to perform a method comprising: providing, by the processing circuitry, one or more reference images, each associated with (a) a corresponding marker, and (b) a corresponding action; obtaining, by the processing circuitry, an image including a given marker applied on a flowable-matter substrate; identifying, by the processing circuitry, a matching reference image of the reference images, the matching reference image being associated with the marker corresponding to the given marker; and upon identifying the matching reference image, performing, by the processing circuitry, the action associated with the matching reference image.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic illustration of identification of a marker on a flowable-matter substrate, in accordance with the presently disclosed subject matter;

FIG. 2 is a schematic illustration of adjustment of a reference image including a marker for enabling identification of the marker when applied on a flowable-matter substrate, in accordance with the presently disclosed subject matter;

FIG. 3 is a block diagram schematically illustrating one example of a marker identification system, in accordance with the presently disclosed subject matter; and

FIG. 4 is a flowchart illustrating one example of a sequence of operations carried out for identification of a marker applied on a flowable-matter substrate, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “providing”, “obtaining”, “identifying”, “performing”, “analyzing” or the like, include action and/or processes of a computer that manipulate and/or transform data into other data, said data represented as physical quantities, e.g. such as electronic quantities, and/or said data representing the physical objects. The terms “computer”, “processor”, “processing circuitry” and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

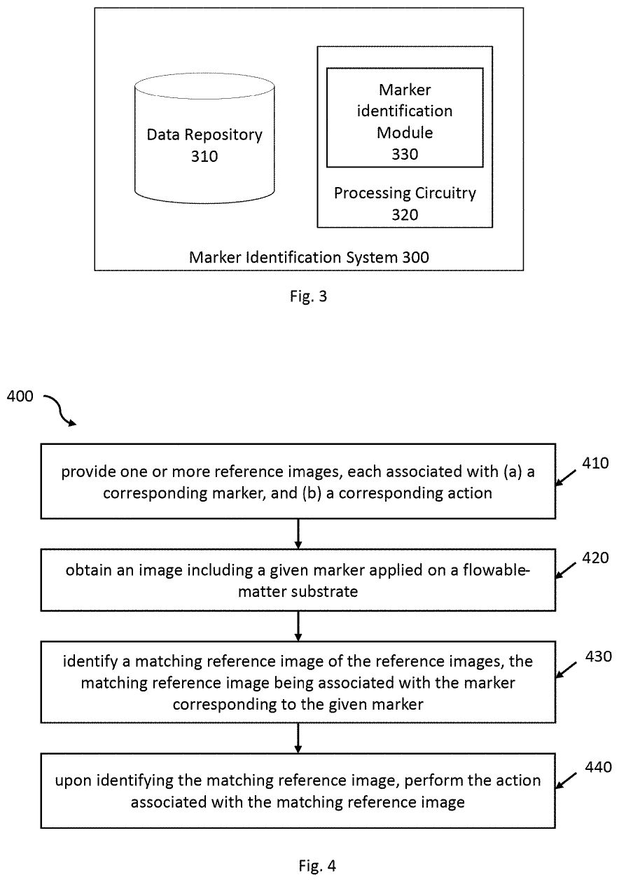

In embodiments of the presently disclosed subject matter, fewer, more and/or different stages than those shown in FIG. 4 may be executed. In embodiments of the presently disclosed subject matter one or more stages illustrated in FIG. 4 may be executed in a different order and/or one or more groups of stages may be executed simultaneously. FIG. 3 illustrates a general schematic of the system architecture in accordance with an embodiment of the presently disclosed subject matter. Each module in FIG. 3 can be made up of any combination of software, hardware and/or firmware that performs the functions as defined and explained herein. The modules in FIG. 3 may be centralized in one location or dispersed over more than one location, as detailed herein. In other embodiments of the presently disclosed subject matter, the system may comprise fewer, more, and/or different modules than those shown in FIG. 3.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

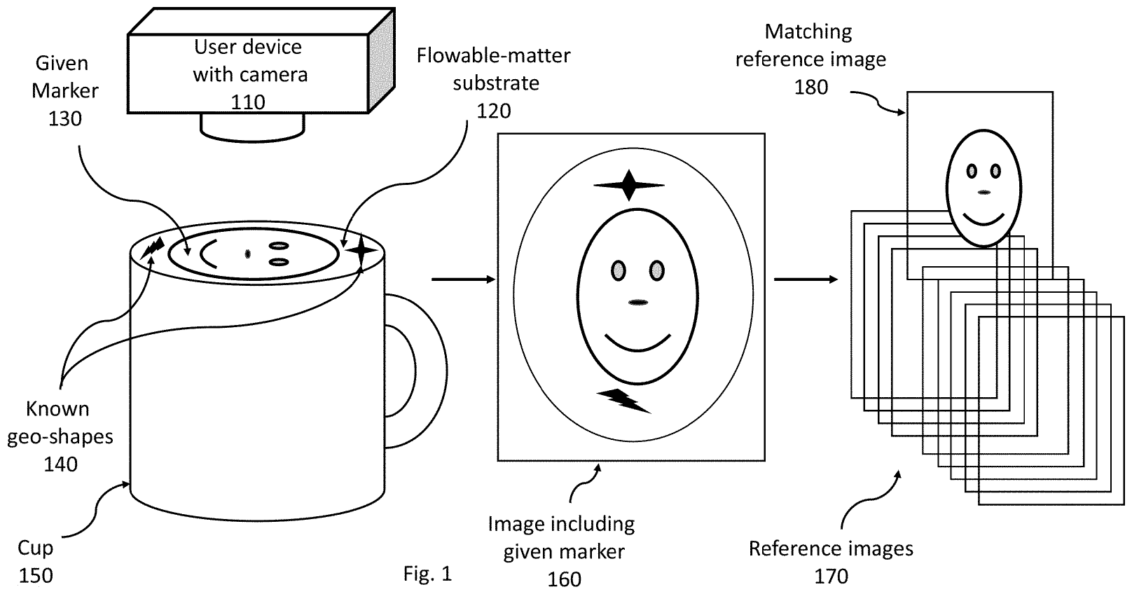

Bearing this in mind, attention is drawn to FIG. 1, a schematic illustration of identification of a marker on a flowable-matter substrate, in accordance with the presently disclosed subject matter.

In accordance with the presently disclosed subject matter, a given marker 130 is applied on a flowable-matter substrate 120. The flowable-matter substrate 120 can be an upper surface of any matter that can flow, including, but not limited to, edible-matter surfaces of liquid (e.g. beverages such as cocktail, milkshake, beer, coffee, tea, (e.g. chia, matcha, etc.), fruit shake, vegetable shake, soda, yogurt) or foam foam of a beverage). Examples of foams include, but are not limited to: beer foam, egg-whites foam, milk-foam, and milk-substitute foam, soybean foam, aquafaba foam, chickpea foam, nitro foam (meaning a beverage infused with nitrogen, causing a foam mixture of the beverage and nitrogen bubbles), quillaia extract, yucca extract, etc. In the example illustrated at FIG. 1, the flowable-matter substrate 120 is an upper surface of a drinkable liquid placed in a cup 150. The liquid can be, for example, coffee and the upper surface thereof can be made of foamed milk.

The given marker 130 can be based on a real-world image captured by a camera (e.g. a selfie of a person, captured, for example by a user device with a camera 110), or it can be a computer-generated image, that can optionally be provided by a content provider/manufacturer. The given marker 130 can be applied on the flowable-matter substrate 120 by a printer (e.g. Ripple Maker™ by Ripples™ Ltd.) printing edible ink (e.g. the ink provided in Ripples Ltd.'s Ripples Pod—natural based extracts for decoration).

In some cases, in addition to the given marker, one or more known geometrical shapes (also referred to herein as “geo-shapes”) 140 (e.g. rectangles, triangles, polygons, etc.) are also applied on a flowable-matter substrate 120. Such known geo-shapes 140 enable identification of a sub-portion of the image comprising the given marker 130 when an image including the given marker 130 is analyzed, as further detailed herein.

In some cases, the amount and/or distribution of the geo-shapes 140 can be determined using image analysis of the given marker 130. The parameter based on which the amount and/or distribution of geo-shapes 140 is determined can be a number of vertices that are identified on the given marker 130. It is to be noted that the more vertices exist, the easier it is for image processing algorithms to identify the given marker 130, especially when it is applied on the flowable-matter substrate 120. To the contrary, in some cases, a low number of vertices can render the given marker 130 unidentifiable by image analysis, especially when it is applied on the flowable-matter substrate 120.

In case geo-shapes are to be added, the geo-shapes 140 can be obtained from a data repository which comprises a plurality of distinct geometrical shapes 140, each having at least one vertex. In some cases, some, or all of the geo-shapes 140 stored on the data repository, can be an external contour. In cases such geo-shapes 140 are closed, they can have an empty center. In such cases, the contour can have a certain thickness so that each vertex is actually doubled, thereby increasing the number of vertices on the geo-shape 140. The vertex doubling is a result of the fact that the contour actually has two borders—an internal border, facing the inside of the geo-shape, and an external border, facing the outside of the geo-shape. Each border is actually a line that connects to another line in a respective vertex.

The geo-shapes 140 to be added can in some cases be selected so that the combination of geo-shapes 140 that are applied on the flowable-matter substrate 120 is uniquely associated with a respective distinct marker. In such cases, the marker can be identified by identifying the combination of geo-shapes 140 that is uniquely associated therewith.

The geo-shapes 140 can be distributed around the given marker 130, e.g. in a circular manner. This will result in presence of identifiable vertices around the given marker 130, which will enable identification of a sub-portion of the image comprising the given marker 130.

A user (e.g. a consumer) takes a picture including the given marker 130 and optionally one or more of the known geo-shapes 140 (if such exist), using a user device with a camera 110 (e.g. a smartphone). The result is an image including the given marker 160, as shown in FIG. 1.

The image is analyzed to identify a sub-portion thereof which comprises the given marker 130. In some cases, the known geo-shapes 140 can be utilized for this purpose, as those are easily identifiable using known image analysis techniques. The known geo-shapes 140 can be distributed in a manner that defines the sub-portion of the image that comprises the given marker 130, so that upon identification of the known geo-shapes 140, the sub-portion is also identified.

The sub-portion of the image is then compared with reference images 170 that can be stored on a data repository. Each of the reference images 170 is associated with a corresponding marker and with a corresponding action to be performed when an image that comprises the corresponding marker is identified. When a matching reference image 180 that is associated with the given marker 130 is found, the action that corresponds to the matching reference image 180 can be triggered and performed. For example, the user device with the camera 110 (e.g. a smartphone) can display certain notification or content (e.g. Augmented Reality (AR) content) to a user (e.g. the consumer, a bartender, a barista, or any other user). It is to be noted that in some cases the content can be personalized (e.g. a certain user that has a birthday can be provided with an AR birthday greeting). It is to be further noted that in some cases the content can be provided to the user when one or more rules are met (e.g. when the user is the consumer and she reached an allowed limit of alcohol consumption—the content can be an AR notification indicating that she will not be allowed to order another alcoholic beverage).

As indicated herein, the given marker 130 can be based on a real-world image, or on a computer-generated image. However, due to the fact that the given marker 130 is applied on a flowable-matter substrate, when an image thereof is captured, the given marker 130 has different properties when compared to its properties in the original image (be it a real-world image, or a computer-generated image). The difference can be in one or more of the following parameters: color, blur, hue, sharpness, intensity, contrast, saturation, noise, etc. Such difference in properties can result in poor, on non-existent, capability to match the sub-portion of the image comprising the given marker 130 with the original image on which it is based. Accordingly, the reference images 170 can be manipulations of corresponding original images that are aimed adjusting the parameters of the reference images 170 to match, or at least to be more similar, to the properties of the images that are captured by the user devices.

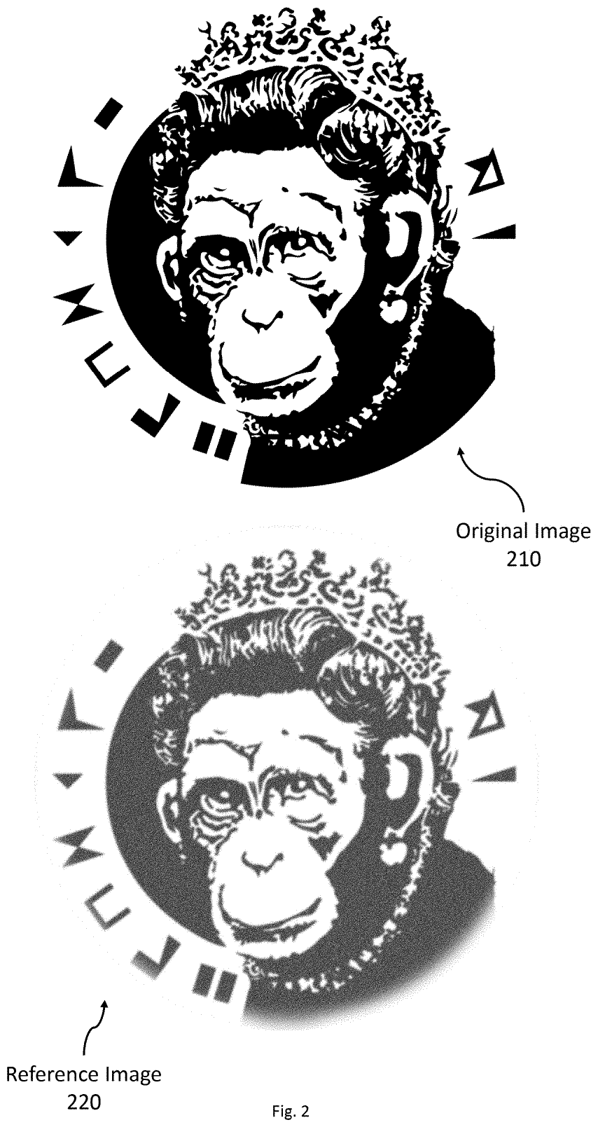

In order to exemplify this, attention is drawn to FIG. 2, a schematic illustration of adjustment of a reference image including a marker for enabling identification of the marker when applied on a flowable-matter substrate, in accordance with the presently disclosed subject matter.

In the figure, an original image 210 is shown, as provided by a content provider and with addition of geo-shapes 140. The original image 210 has respective properties, such as color, blur, hue, sharpness, intensity, contrast, saturation, noise level, etc. However, when such image is printed on a flowable-matter substrate, it's appearance changes, so that when an image of the printed original image 210 is captured, it does not look the same. Accordingly, the original image 210 can be manipulated to more closely resemble the appearance of an image that includes the printout of the original image 210 so that it can be used as a reference image, which gives rise to reference image 220.

Turning to FIG. 3, there is shown a block diagram schematically illustrating one example of a marker identification system, in accordance with the presently disclosed subject matter.

According to the presently disclosed subject matter, marker identification system 300 comprises a processing circuitry 320. Processing circuitry 320 can be one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant marker identification system 300 resources and for enabling operations related to marker identification system's 300 resources.

Processing circuitry 320 comprises a marker identification module 330, configured to identify, markers applied (e.g. printed) on flowable-matter substrates (e.g. foams), as further detailed herein, inter alia with reference to FIGS. 1, 2 and 4.

Marker identification system 100 further comprises, or is otherwise associated with, a data repository 310 (e.g. a database, a storage system, a memory including Read Only Memory—ROM, Random Access Memory—RAM, or any other type of memory, etc.) configured to store data, including geo-shapes 140 (e.g. circles, rectangles, triangles, polygons, etc.), reference images (each associated with (a) a corresponding marker and (b) a corresponding action, as further detailed herein), etc. The reference images are used by the marker identification module 330 to identify markers applied on flowable-matter substrates. Data repository 310 can be further configured to enable retrieval and/or update and/or deletion of the stored data. It is to be noted that in some cases, data repository 310 can be distributed, while the marker identification system 300 has access to the information stored thereon, e.g. via a wired or wireless network to which marker identification system 300 is able to connect.

Attention is now drawn to FIG. 4 is a flowchart illustrating one example of a sequence of operations carried out for identification of a marker applied on a flowable-matter substrate, in accordance with the presently disclosed subject matter.

According to certain examples of the presently disclosed subject matter, marker identification system 300 can be configured to perform a marker identification process 400, e.g. utilizing the marker identification module 330.

For this purpose, marker identification system 300 is configured to provide one or more reference images 170, each associated with (a) a corresponding marker, and (b) a corresponding action (block 410). An example of a reference image is reference image 220 shown in FIG. 2.

As indicated herein, each reference image is associated with a corresponding marker, that can be any object (e.g. symbol, shape, group of shapes, or any other object) included in the reference image, whether such object is only a part of the reference image, or if such object is the entirety of the reference image. Each reference image is also associated with a corresponding action that can be, for example displaying content (that can optionally be Augmented Reality (AR) content), provisioning of a notification, etc.

In some cases, the reference images 170 are manipulations of corresponding original images (whether computer-generated or real-world images) including the corresponding marker. As indicated herein, inter alia due to the fact that the given marker 130 is applied on a flowable-matter substrate, when an image thereof is captured, the given marker 130 has different properties when compared to its properties in the original image (be it a real-world image, or a computer-generated image). The difference can be in one or more of the following parameters: color, blur, hue, sharpness, intensity, contrast, saturation, noise, etc. Such difference in properties can result in poor, on non-existent, capability to match the sub-portion of the image comprising the given marker 130 with the original image on which it is based. Accordingly, the reference images 170 can be manipulations of corresponding original images that are aimed adjusting the parameters of the reference images 170 to match, or at least to be more similar, to the properties of the images that are captured by the user devices.

The reference images 170 can be manipulation of corresponding original images that are aimed adjusting the parameters of the reference images 170 to match, or at least to be more similar, to the properties of the images that are captured by the user devices. The manipulations can be manipulations of the original image's color (changing the original image's color), blur (creating a blur effect on the original image), hue (changing the original image's hue), sharpness (changing the original image's sharpness), intensity (changing the original image's intensity), contrast (changing the original image's contrast), saturation (changing the original image's saturation), noise (adding a particle noise effect on the original image), etc.

It is to be noted that the original images can be provided by content manufacturers, or it can be provided via a user device used to capture the original image (e.g. a user captures a selfie, or an image of another person/object/scene, and the image is transmitted to the marker identification system 300).

Marker identification system 300 is further configured to obtain an image including a given marker 130 applied on a flowable-matter substrate 120 (block 420). The image can be obtained from a user device with camera 110 (or by any other device having a camera) that captures the image and transmits it to the marker identification system 300, via a wired/wireless network connection.

As for the flowable-matter substrate 120, on which the given marker 130 is applied, it can be made of edible material. In some cases, the flowable-matter substrate 120 can be a liquid substrate, such as a surface of a beverage. The edible material can be a surface of a beverage (e.g. coffee, beer, cocktail, milkshake, tea (e.g. chia, matcha, etc.), fruit shake, vegetable shake, soda, yogurt) that can optionally be a layer of edible foam (e.g. a foam of a beverage such as a coffee or a beer, etc.).

The given marker 130 can be applied on the flowable-matter substrate 120 by a printer printing edible ink. An example of such printer is Ripple Maker™ (by Ripples™ Ltd. from Petach Tikva, Israel), which can print edible ink, e.g. as provided in Ripples Pods (by Ripples Ltd. from Petach Tikva, Israel). The edible ink itself can optionally be invisible in the visible spectrum and visible in an Ultra Violet (UV) spectrum, or in any other spectrum, as long as a suitable camera can acquire an image thereof in which the edible ink (and therefore the given marker 130) is visible.

It is to be noted that unless certain actions are made, the optical density of the given marker 130 that is applied on the flowable-matter substrate 120 (as opposed to printing on paper or other solid surfaces) can be low in a manner that has a negative effect on image processing algorithms when processing an image of the given marker 130. Therefore, in some cases, it is desirable to apply the given marker 130 (and optionally the geo-shapes 140), by printing each pixel at least twice (e.g. by having each print pass of the print head at least partially overlap a preceding print pass, or by printing at a lower printing speed, thereby having multiple ink droplets land on each pixel) and/or by enhancing the dot gain and/or the calibration curves of the print files printed on the flowable-matter substrate 120. In some cases, dim ambient lighting can have an effect on the optical density as well. In such cases, it may be desirable to utilize lights of the user device with camera 110 in order to improve the optical density.

After obtaining the image at block 420, marker identification system 300 is further configured to identify a matching reference image of the reference images 170 obtained at block 410, the matching reference image being associated with the marker corresponding to the given marker (block 430). As indicated herein, each of the reference images 170 is associated with a corresponding marker, and the image obtained at block 420 includes a given marker 130. Accordingly, the marker identification system 300 can try to find, within the reference images 170, a reference image that is associated with the given marker 130, e.g. by image comparison.

In some cases, it may be challenging to identify the given marker 130 within the image obtained in block 420. Accordingly, in some cases, in addition to the given marker 130, a plurality of known geometrical shapes 140 are also applied on the flowable-matter substrate 120. In such cases, the image obtained at block 420 includes the given marker 130 and the known geo-shapes 140 that are applied on the flowable-matter substrate 120 in a manner that enables identification of a sub-portion of the image that includes the given marker 130. This enables using image analysis in order to identify the sub-portion of the image that includes the given marker 130. Once the sub-portion of the image that includes the given marker 130 is identified, it can be used, instead of the entire image, in order to find a matching reference image 180 that matches the content within the sub-portion (including the given marker 130).

As indicated herein, in some cases, the amount and/or distribution of the geo-shapes 140 can be determined using image analysis of the given marker 130. The parameter based on which the amount and/or distribution of geo-shapes 140 is determined can be a number of vertices that are identified on the given marker 130). It is to be noted that the more vertices exist, the easier it is for image processing algorithms to identify the given marker 130, especially when it is applied on the flowable-matter substrate 120. To the contrary, in some cases, a low number of vertices can render the given marker 130 unidentifiable by image analysis, especially when it is applied on the flowable-matter substrate 120.

In case geo-shapes are to be added, the geo-shapes 140 can be obtained from data repository 310 which comprises a plurality of distinct geometrical shapes 140, each having at least one vertex. In some cases, some, or all of the geo-shapes 140 stored on the data repository, can be an external contour. In cases such geo-shapes 140 are closed, they can have an empty center. In such cases, the contour can have a certain thickness so that each vertex is actually doubled, thereby increasing the number of vertices on the geo-shape 140. The vertex doubling is a result of the fact that the contour actually has two borders—an internal border, facing the inside of the geo-shape, and an external border, facing the outside of the geo-shape. Each border is actually a line that connects to another line in a respective vertex.

The geo-shapes 140 to be added can in some cases be selected so that the combination of geo-shapes 140 that are applied on the flowable-matter substrate 120 is uniquely associated with a respective distinct marker. In such cases, the marker can be identified by identifying the combination of geo-shapes 140 that is uniquely associated therewith.

The geo-shapes 140 can be distributed around the given marker 130, e.g. in a circular manner. This will result in presence of identifiable vertices around the given marker 130, which will enable identification of a sub-portion of the image comprising the given marker 130.

Upon identifying the matching reference image 180, marker identification system 300 is configured to perform the action associated with the matching reference image 180 (block 440). As indicated herein, each of the reference images 170 is associated with a corresponding action, which can be performed upon finding the matching reference image 180.

The action that is associated with the matching reference image 180 can include one or more of: (a) displaying augmented reality content associated with the matching reference image 180 to a user (e.g. the consumer, a bartender, a barista, or any other user) of the marker identification system 300 or (b) providing a notification to the user (e.g. the consumer, a bartender, a barista, or any other user) of the marker identification system 300.

For example, the user device with the camera 110 (e.g. a smartphone) can display certain notification or content (e.g. Augmented Reality (AR) content) to a user (e.g. the consumer, a bartender, a barista, or any other user).

It is to be noted that in some cases the content can be personalized (e.g. a certain user that has a birthday can be provided with an AR birthday cake). In such cases, the content can be personalized based on characteristics of the user, such as (non-limiting): age, birthdate, weight, gender, historical information about past interactions with the marker identification system 300, etc.

It is to be further noted that in some cases the content can be provided to the user when one or more rules are met (e.g. when the user is the consumer and she reached an allowed limit of alcohol consumption—the content can be an AR notification indicating that she will not be allowed to order another alcoholic beverage).

It is to be noted that although process 400 refers at block 420 to obtainment of an image which includes a single given marker 130 applied on a flowable-matter substrate 120, in some cases, the image that is obtained at block 420 can include a plurality of markers applied on a plurality of respective flowable-matter substrates 120. In such cases, matching reference images can be identified for each of the plurality of markers at block 430, and the action performed at block 240 can involve interaction between a plurality of users. As a nonlimiting example, assuming that two friends arrive at a bar, and each orders a beer with a certain image printed thereon. When the beer is supplied, one of the friends can take a picture of both beers (on which the respective markers were applied) in a single shot. The system 300 can identify both markers printed on the beers and activate a game in which the two friends play against each other.

It is to be noted, with reference to FIG. 4, that some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed methods. The presently disclosed subject matter further contemplates a machine-readable memory tangibly embodying a program of instructions executable by the machine for executing the disclosed methods.

1. A system for identifying markers on flowable-matter substrates, the system comprising a processing circuitry configured to:
provide one or more reference images, each associated with (a) a corresponding marker, and (b) a corresponding action;
obtain an image including a given marker applied on a flowable-matter substrate;
identify a matching reference image of the reference images, the matching reference image being associated with the marker corresponding to the given marker; and
upon identifying the matching reference image, perform the action associated with the matching reference image.

2. The system of claim 1, wherein the reference images are manipulations of corresponding original images including the corresponding marker.

3. The system of claim 2, wherein the manipulations include at least one of: (a) color manipulations manipulating the colors of the original images, (b) blur manipulations creating a blur effect on the original images, (c) hue manipulations changing the hue of the original images, or (d) adding of noise to the original images.

4. (canceled)

5. The system of claim 1, wherein (a) the image includes a plurality of known geometrical shapes enabling identification of a sub-portion of the image comprising the marker, (b) the identification of the matching reference image includes analyzing the image to identify the geometrical shapes, thereby identifying the sub-portion, and (c) the matching reference image being the reference image that matches a content within the sub-portion.

6. The system of claim 1, wherein the action associated with the matching reference image includes one or more of: (a) displaying augmented reality content associated with the matching reference image to a user of the system, or (b) providing a notification to the user of the system.

7-8. (canceled)

9. The system of claim 1, wherein the flowable-matter substrate is a surface of a beverage, and the image is provided by a consumer of the beverage.

10. The system of claim 1, wherein the flowable-matter substrate is edible.

11. The system of claim 10, wherein the flowable-matter substrate made of edible foam.

12. The system of claim 11, wherein the foam is of a beverage.

13. (canceled)

14. The system of claim 10, wherein the given marker is applied on the flowable-matter substrate by a printer printing edible ink.

15. (canceled)

16. The system of claim 1, wherein the image is captured by a user device of a user at an unknown point-in-time after the given marker is applied on the flowable-matter substrate.

17. The system of claim 1, wherein the image is captured by a user device of a user from a distance from the flowable-matter substrate that is unknown when the given marker is applied on the flowable-matter substrate.

18. The system of claim 1, wherein the image is captured by a user device of a user in lighting conditions that are unknown when the given marker is applied on the flowable-matter substrate.

19. A method for identifying markers on flowable-matter substrates, the method comprising:
providing, by a processing circuitry, one or more reference images, each associated with (a) a corresponding marker, and (b) a corresponding action;
obtaining, by the processing circuitry, an image including a given marker applied on a flowable-matter substrate;
identifying, by the processing circuitry, a matching reference image of the reference images, the matching reference image being associated with the marker corresponding to the given marker; and
upon identifying the matching reference image, performing, by the processing circuitry, the action associated with the matching reference image.

20. The method of claim 19, wherein the reference images are manipulations of corresponding original images including the corresponding marker.

21. The method of claim 20, wherein the manipulations include at least one of: (a) color manipulations manipulating the colors of the original images, (b) blur manipulations creating a blur effect on the original images, (c) hue manipulations changing the hue of the original images, or (d) adding of noise to the original images.

22. (canceled)

23. The method of claim 19, wherein (a) the image includes a plurality of known geometrical shapes enabling identification of a sub-portion of the image comprising the marker, (b) the identification of the matching reference image includes analyzing the image to identify the geometrical shapes, thereby identifying the sub-portion, and (c) the matching reference image being the reference image that matches a content within the sub-portion.

24. The method of claim 19, wherein the action associated with the matching reference image includes one or more of: (a) displaying augmented reality content associated with the matching reference image to a user of the system, or (b) providing a notification to the user of the system.

25. (canceled)

26. The method of claim 24, wherein the notification is provided to the user upon one or more rules being met.

27-36. (canceled)

37. A non-transitory computer readable storage medium having computer readable program code embodied therewith, the computer readable program code, executable by at least one processing circuitry of a computer to perform a method comprising:
providing, by the processing circuitry, one or more reference images, each associated with (a) a corresponding marker, and (b) a corresponding action;
obtaining, by the processing circuitry, an image including a given marker applied on a flowable-matter substrate;
identifying, by the processing circuitry, a matching reference image of the reference images, the matching reference image being associated with the marker corresponding to the given marker; and
upon identifying the matching reference image, performing, by the processing circuitry, the action associated with the matching reference image.
